(19) United States
(12) Patent Application Publication
(10) Pub. No.: US 2024/0155272 A1
(43) Pub. Date: May 9, 2024

(54) Multifunction Accessory

(71) Applicant: James Tsai, Mercer Island, WA (US)

(72) Inventor: James Tsai, Mercer Island, WA (US)

(21) Appl. No.: 17/981,483

(22) Filed: Nov. 7, 2022

(51) Int. Cl. H04R 1/02; H04R 1/10

(52) U.S. Cl. CPC H04R 1/02; H04R 1/1025; H04R 2420/07

(57) ABSTRACT

A multifunction accessory for a multimedia device is described. The accessory may connect to the multimedia device directly via a magnetic coupler, a suction cup, or another type of connector. Alternatively, it may connect to an add-on multimedia device case via a magnetic coupler, a suction cup, or another type of connector. The accessory may provide kickstand functionality, as well as storage or charging for wireless earbuds.

### FIELD

I) This disclosure relates generally to the field of a multifunction accessory for a multimedia device.

### BACKGROUND

Cell phones have progressed over time from devices used to make phone calls to providing many of the functions for which people use a computer. With smartphones, people make calls, play games, make video calls, watch videos, use utility applications, such as spreadsheets and word processors, and many other applications.

### SUMMARY

II) The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

While smartphones are very useful with the computing power they provide, the form factor is not always ideal for all applications. For example, when watching a video or having a video call, having a smartphone flat on a desk is often not optimal for watching the screen or being on camera.

The instant application discloses, among other things, a multifunction accessory for a multimedia device, such as a smartphone. The accessory may connect to the multimedia device directly via a magnetic coupler, a suction cup, or another type of connector. Alternatively, it may connect to a multimedia device case via a magnetic coupler, a suction cup, or another type of connector. The accessory may provide kickstand functionality, storage, and charging for wireless earbuds.

### BRIEF DESCRIPTION OF THE DRAWINGS

FIG. 1 illustrates a case and a multifunction accessory that may couple to the case via magnets, according to one implementation.

FIG. 2 shows a view of a second portion of a multifunction accessory, according to one implementation.

FIG. 3 shows a multifunction accessory being used as a kickstand for a case, according to one implementation.

FIG. 4 shows Multifunction Accessory 130 being used as a kickstand for Case 100, according to another implementation.

### DETAILED DESCRIPTION

In the following detailed description, specific details are set forth by examples. However, it should be apparent to those skilled in the art that the instant disclosure is not so limited and that the instant disclosure includes modifications to the specific examples described herein without departing from the spirit and scope.

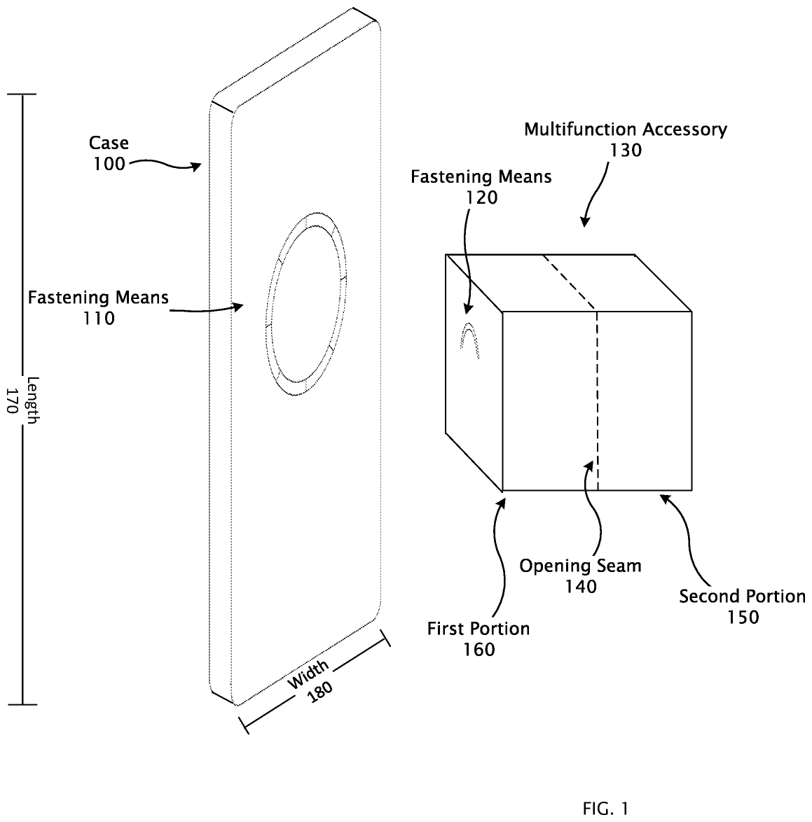

FIG. 1 illustrates Case 100 and Multifunction Accessory 130 that may couple to Case 100 via Fastening Means 110 and 120, according to one implementation. Fastening Means 110 and 120 may be magnets, a suction cup and a surface to which it may be attached, a reusable adhesive, or any other means of removably attaching Multifunction Accessory 130 to Case 100.

Case 100 may be part of a multimedia device or may be a protective cover that slips onto a multimedia device, for example. The multimedia device may be a smartphone, a tablet, or a video player, for example. Fastening Means 110 may be integrated into Case 100 or may be attached in some manner, such as tape, adhesives, screws, nuts and bolts, or some other fasteners.

In this implementation, Fastening Means 110 may be magnet disposed in a circle, with corresponding Fastening Means 120 being magnets disposed in an arc. This configuration may allow Multifunction Accessory 130 to couple with Case 100 at different angles, which may allow flexibility, for example, when using Multifunction Accessory 130 as a kickstand, allowing the multimedia device to be viewed with a vertical orientation along Length 170 or Width 180. It may also allow a different angle to be used to provide a stable position n an uneven surface.

In one implementation, Fastening Means 120 may be attached to First Portion 160, allowing Multifunction Accessory 130 to be removably attached to Case 100. In another implementation, Fastening Means 120 may be attached to Second Portion 150, allowing Multifunction Accessory 130 to be removably attached to Case 100.

Multifunction Accessory 130 may also be, for example, a case for earbuds. It may also provide charging for wireless earbuds. Opening Seam 140 may allow Multifunction Accessory to open for storage for earbuds or other small items. First Portion 160 and Second Portion 150 may separate completely or may be hinged or otherwise attached to each other.

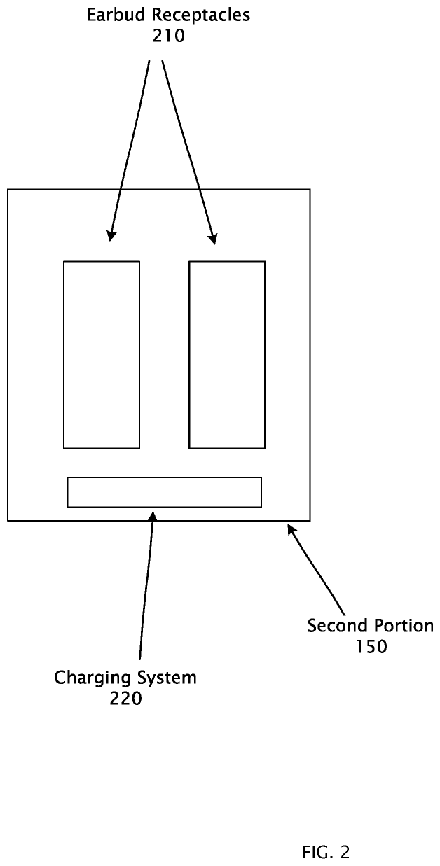

FIG. 2 shows a view of Second Portion 150. Second Portion 150 may have one or more Earbud Receptacle 210, each configured to hold an earbud. In another implementation, other devices may be stored in Second Portion 150.

Second Portion 150 may also have Charging System 220, which may allow wireless or wired charging of earbuds or other devices. Charging System 220 may include a power supply such as a battery, a rechargeable battery, a solar cell, or other power sources. One having skill in the art will recognize that many different types of power supplies may be used for Charging System 220.

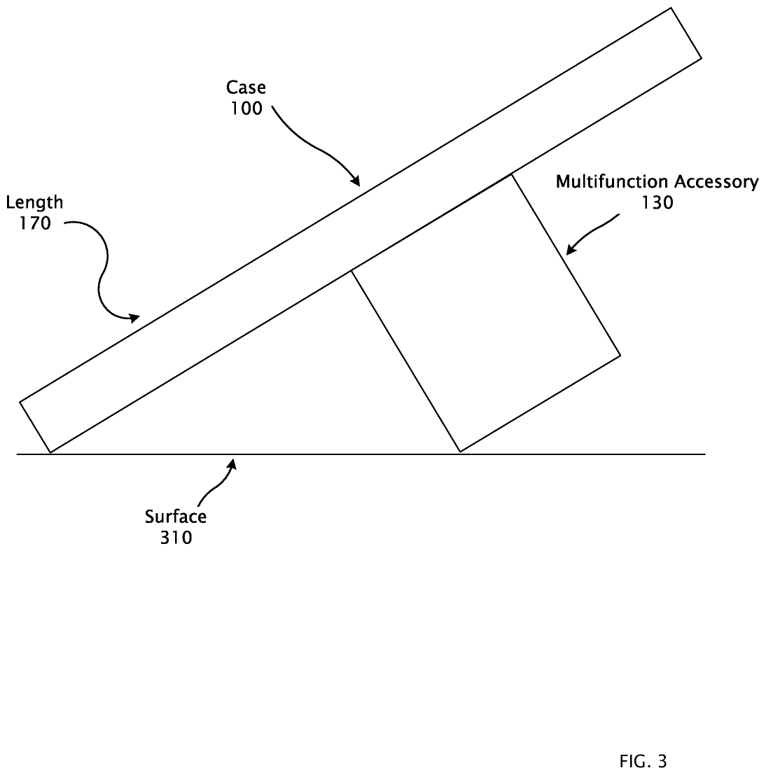

FIG. 3 shows Multifunction Accessory 130 being used as a kickstand for Case 100, according to one implementation. Multifunction Accessory 130 may be coupled to Case 100 using Fastening Means 110.

When a multimedia device is being used to watch a video or is being used for a video call, it may be difficult to see a screen or position a camera to be in the camera's view. Holding the multimedia device can be tiring, and it may move enough to make it hard to watch the screen or to have a steady shot with the camera.

Multifunction Accessory 130 may be used as a kickstand for Case 100, allowing hands-free use of Multifunction Accessory 130 with a comfortable viewing angle or camera view. Case 100 and Multifunction Accessory 130 may rest on Surface 310, which may be, for example, a desktop or a tabletop.

In this implementation, Multifunction Accessory 130 is used to hold Case 100 with Length 170 aligned with a vertical viewing of a screen. This alignment may be a useful configuration for a video call or playing some games, for example.

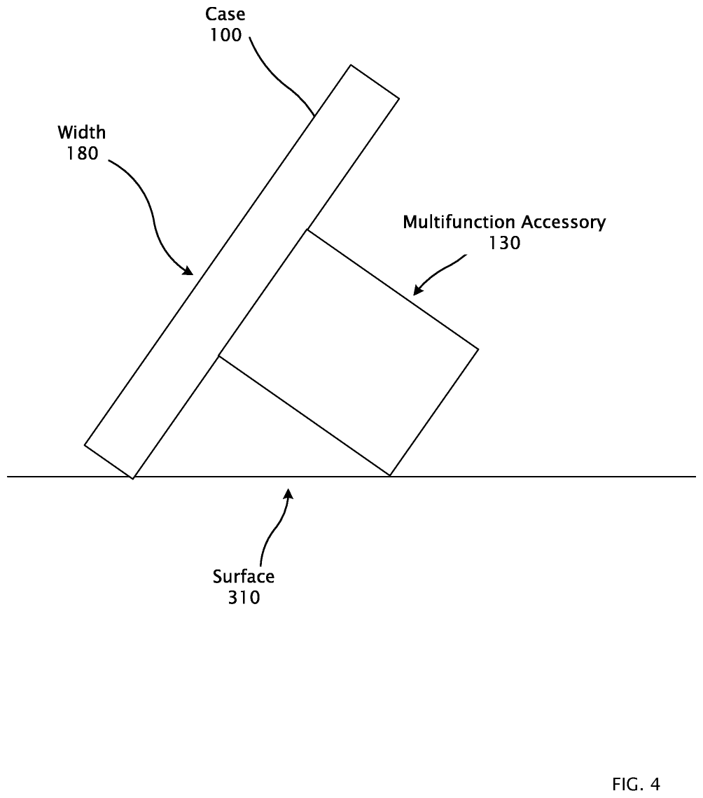

FIG. 4 shows Multifunction Accessory 130 being used as a kickstand for Case 100, according to another implementation.

When a multimedia device is being used to watch a video or is being used for a video call, it may be difficult to see a screen or position a camera to be in shot. Holding the multimedia device can be tiring, and it may move enough to make it hard to watch the screen or to have a steady shot with the camera.

Multifunction Accessory 130 may be used as a kickstand for Case 100, allowing hands-free use of Multifunction Accessory 130, with a comfortable viewing angle or camera view. Multifunction Accessory 130 may be coupled to Case 100 using Fastening Means 110 and 120.

In this implementation, Multifunction Accessory 130 may be used to hold Case 100 with Width 180 aligned with a vertical viewing of a screen. This configuration may be useful for watching a video or working on applications, for example.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A multifunction accessory, comprising:
a fastening means, the fastening means configured for the multifunction accessory to be removably coupled to a multimedia device;
and a wireless earbud receptacle, configured to hold one or more wireless earbuds.

2. The multifunction accessory of claim 1, wherein the fastening means allows for the multifunction accessory to be coupled to the multimedia device at various angles.

3. The multifunction accessory of claim 1 further comprising a charging system, the charging system configured to charge the one or more wireless earbuds.

4. The multifunction accessory of claim 2, wherein the charging system comprises a power supply comprising a rechargeable battery.
